(19) United States
(12) Patent Application Publication
(10) Pub. No.: US 2023/0220801 A1
(43) Pub. Date: Jul. 13, 2023

(54) DEVICE FOR FILTERING COOLING AIR OF A TURBOMACHINE TURBINE

(71) Applicant: SAFRAN AIRCRAFT ENGINES, PARIS (FR)

(72) Inventors: Hassane AMARA, MOISSY-CRAMAYEL (FR); Damien GREUET, MOISSY-CRAMAYEL (FR); Jean Michel Anthime PAPAIL, MOISSY-CRAMAYEL (FR)

(21) Appl. No.: 18/008,906

(22) PCT Filed: May 26, 2021
(86) PCT No.: PCT/FR2021/050950

§ 371 Date: Dec. 7, 2022

(30) Foreign Application Priority Data
Jun. 16, 2020 (FR) FR2006237

(51) Int. Cl. F02C 7/18; B01D 45/16; B01D 46/24; B01D 46/48; B01D 50/20

(52) U.S. Cl. CPC F02C 7/18; B01D 45/16; B01D 46/2403; B01D 46/48; B01D 50/20; F05D 2220/32; F05D 2260/20

(57) ABSTRACT

A device for filtering a flow of cooling air for cooling a low-pressure turbine of a turbomachine, includes a duct having a geometry configured to centrifuge the flow of cooling air passing through the duct, the duct having openings dimensioned to enable a separation of the solid particles contained in the flow of cooling air being centrifuged.

### TECHNICAL FIELD OF THE INVENTION

The field of the invention relates to the cooling and ventilation of a turbine fitting a turbomachine, and more particularly a low-pressure turbine.

More particularly, the invention relates to a filtration device for filtering a cooling air flow from a turbomachine low-pressure turbine.

### TECHNICAL BACKGROUND

In the present application, the terms “upstream” and “downstream” are defined with respect to the normal flow direction of gas (upstream to downstream) through a turbomachine.

The axis of rotation of a rotor of the turbomachine is also referred to as the “axis of the turbomachine” or “engine axis”. The axial direction is the direction of the axis of the turbomachine and a radial direction is a direction perpendicular to the axis of the turbomachine and intersecting this axis. Similarly, an axial plane is a plane containing the axis of the turbomachine, and a radial plane is a plane perpendicular to this axis.

Unless otherwise specified, the adjectives “internal”, “inner”, “external”, “outer” are used in the present application in reference to a radial direction such that the internal part of an element is, along a radial direction, closer to the axis of the turbomachine than the external part of the same element.

Conventionally, a turbomachine includes, from upstream to downstream, that is, in the flow direction of the gas flows, a fan, one or more compressors, a combustion chamber, one or more turbines, and a nozzle for ejecting the combustion gases leaving the turbine or turbines.

Thus, a turbomachine comprises at least one part dedicated to the compression of the air that it takes in at the inlet. The air compressed by the compressor(s) enters the combustion chamber where it is mixed with a fuel before the resulting mixture is burnt and produces hot combustion gases. The hot combustion gases are then expanded in a high-pressure stage of the turbine and then in at least one low-pressure stage of this same turbine.

Thus, during the operation of the turbomachine, the various low-pressure turbine stages have combustion gases whose temperature is very high, passing therethrough.

Conventionally, a low-pressure or high-pressure turbine includes one or more stages, each stage being formed by a series of stationary vanes, forming an assembly called upstream guide vanes, followed by a turbine wheel including a rotor disc on which the so-called moving vanes are secured in cells. The upstream guide vanes divert the gas flow towards the moving vanes of the wheel at an appropriate angle and speed in order to rotatably drive the moving vanes and the rotor assembly of the turbine.

The cells in the rotor discs that receive the roots of the moving vanes are directly exposed to the combustion gases, so it is necessary to cool them to prevent any damage to the discs.

In order to reduce the temperature stress and to ensure a sufficiently long service life of the coupling parts of the vanes (vane roots) and the discs (cells), it is known to cool them by means of cooling air.

For this, it is known to take part of the air flowing out of the flow path of the low-pressure turbine, generally upstream at a high-pressure compressor compartment, and to convey this cooling air, via a supply pipe, called a utility tube, to injectors provided at a turbine centre frame (TCF). The cooling air is thus injected into an inter-disk cavity and dispensed via various lunules and through ports to the cells of the different rotor disks.

The air taken at the high-pressure compressor compartment of a turbomachine may contain residues, particles, such as sand particles for example. In operation, these particles end up being conveyed into the rotor part of the low-pressure turbine and especially into the inter-disc cavity where they build up especially under the ferrules of the annular flanges of the turbine movable discs.

This accumulation of particles forms a relatively large layer, especially at the radially inner faces of the annular flange ferrules, and results in increasing the mass of the discs and therefore of the centrifugal mass of the turbomachine, consequently generating an increase in the mechanical stresses of the different rotating parts and a reduction in the life of these parts.

A second consequence of this accumulation of particles is a reduction in the efficiency of the convection cooling of the various rotating parts, especially the discs, as the built-up particles act as a thermal barrier.

Thus, the invention aims to remedy the above-mentioned drawbacks and provides a filtration device for purifying a cooling air flow taken at a turbomachine compressor by separating solid particles, such as sand, contained in the air flow taken.

### SUMMARY OF THE INVENTION

One purpose of the invention is to provide a technical solution for separating solid particles, such as sand, contained in the air flow taken without significantly impeding the air flow. The solution of the invention therefore attempts to provide a filtration device minimising head loss so as to maintain efficient cooling of the downstream low-pressure turbine rotor.

To this end, one object of the invention is a device for filtering a cooling air flow for cooling a low-pressure turbine of a turbomachine, characterised in that it includes a duct having a geometry configured to centrifuge said cooling air flow passing through said duct, said duct having openings dimensioned to allow separation of the solid particles contained in said cooling air flow being centrifuged, said duct has a circular helix shape inscribed on a cylinder of revolution having an axis of revolution.

By virtue of the device according to the invention, separation of the solid particles contained in the cooling flow is achieved while minimising head losses, which makes it possible to keep the speed of the air flow leaving the filtration device substantially identical to the speed of the incoming air flow. Thus, cooling quality of the rotor of the low-pressure turbine is maintained.

Advantageously, the duct has a circular helix shape inscribed on a cylinder of revolution with an axis of revolution. Thus, the shape of the duct allows with a static element to centrifuge the cooling air flow passing therethrough.

Advantageously, the duct is a tube with a circular cross-section. Thus, head losses are further minimised.

Advantageously, the openings are provided in a radially outer portion of said duct with respect to said axis of revolution. Thus, the openings are made in a portion of the duct into which the solid particles are directed by centrifugal effect.

Advantageously, the filtration device includes a storage tank for storing the solid particles separated from said cooling air flow. Thus, the solid particles separated from the air flow are not released into the turbomachine.

Advantageously, the storage tank has an air-porous shell. Thus, there is no overpressure inside the storage tank.

Advantageously, the filtration device includes a protective enclosure forming the external shell of said filtration device. Thus, the filtration device is protected from shocks and external aggressions.

Advantageously, the protective enclosure has openings allowing the interior of the protective enclosure to be placed in fluid communication with the exterior of the protective enclosure. Thus, a pressure inside the protective enclosure is guaranteed to be lower than the pressure inside the duct, which facilitates the expulsion of solid particles from the duct through the duct openings.

Advantageously, the protective enclosure has an access hatch positioned facing an opening provided in the external shell of the storage tank. Thus, a protection of the interior of the filtration device is guaranteed while allowing easy cleaning operations.

The invention also relates to a system for cooling a low-pressure turbine including a utility tube for conveying a cooling air flow taken at a high-pressure compressor compartment to a low-pressure turbine compartment, said utility tube including a filtration device, said filtration device being positioned between an upstream tube connected to the high-pressure compressor compartment and a downstream tube connected to the low-pressure turbine compartment.

The invention and its various applications will be better understood upon reading the following description and examining the accompanying figures.

### BRIEF DESCRIPTION OF THE FIGURES

The figures are set forth only for indicative and in no way limiting purposes of the invention.

FIG. 1 is a schematic perspective view of a utility tube for conveying cooling air taken at a high-pressure compressor module incorporating a filtration device according to the invention.

FIG. 2 more particularly illustrates one exemplary embodiment of a filtration device according to the invention, in partial axial cross-section along the longitudinal axis of the device.

FIG. 3 more particularly illustrates a transverse section of the spiral tube of the filtration device according to the invention.

FIG. 4 is a schematic diagram illustrating the operation of the filtration device according to the invention.

FIG. 5 is an external view of the filtration device illustrated in FIG. 2.

FIG. 6 is a partial cross-sectional view along a longitudinal plane of the filtration device illustrated in FIG. 2, the cross-section being between the external protective shell and the storage tank inside the filtration device illustrated in FIG. 2.

Unless otherwise specified, a same element appearing in different figures has a single reference.

### DETAILED DESCRIPTION

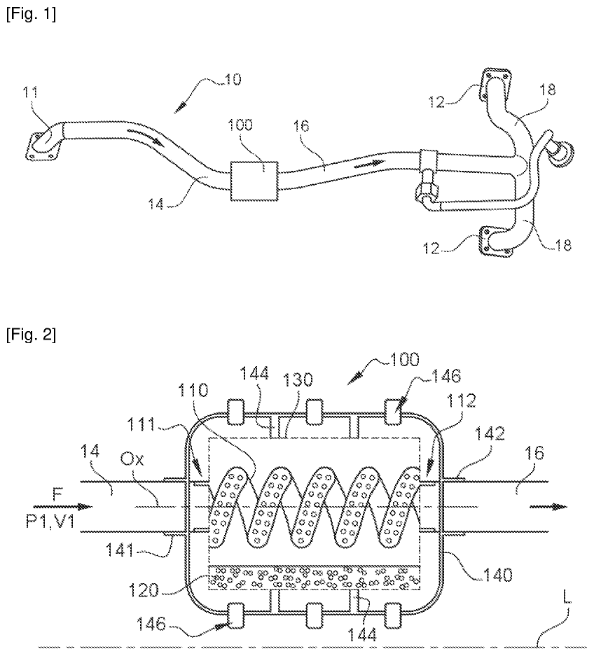

FIG. 1 is a schematic perspective view of a utility tube 10 for conveying cooling air taken at a high-pressure compressor module, incorporating a filtration device 100 according to the invention.

FIG. 2 more particularly illustrates one exemplary embodiment of a filtration device 100 according to the invention, in partial axial cross-section along the longitudinal axis of the device.

The filtration device 100 according to the invention is for filtering a cooling air flow F used for cooling a low-pressure turbine, and more particularly for cooling the rotor of the low-pressure turbine.

The cooling air flow F is taken at an upstream part of the low-pressure turbine, for example at the high-pressure compressor of the turbomachine, and is conveyed to a turbine centre frame (TCF), via a supply pipe, called “utility tube 10”, represented in [FIG. 1].

The utility tube 10 includes an upstream end 11 connected to a part of the high-pressure compressor and configured to allow a cooling air flow F to be taken, and at least one downstream arm with a downstream dispensing end 12 configured to be connected to an injection hole of the turbine centre frame (the utility tube 10 shown by way of example in [FIG. 1] includes two utility arms 18 each having a downstream dispensing end 12).

The filtration device 100 according to the invention is advantageously positioned on this utility tube 10 between the upstream end 11 and the downstream end 12. Thus, the filtration device 100 is interposed between an upstream tube 14 and a downstream tube 16 of the utility tube 10.

With reference to [FIG. 2], the filtration device 100 according to the invention includes a duct 110 in a spiral or circular helix shape inscribed on a cylinder of revolution with an axis of revolution (Ox). The duct 110 is formed according to the exemplary embodiment illustrated by a tube with a circular cross-section.

The spiral tube 110 forming the duct has an upstream end 111 configured to be coupled to the upstream tube 14 of the utility tube 10 and a downstream end 112 configured to be coupled to the downstream tube 16 of the utility tube 10.

The upstream ends 111 and 112 of the spiral tube 110 are secured to the upstream 14 and downstream 16 tubes, respectively, via suitable attachment means, for example by a system of flanges and bolted connections.

The spiral tube 110 has a generatrix drawn in the form of a circular helix, or screw, around a cylinder of revolution with an axis of revolution Ox. Thus, the spiral tube 110 has a plurality of loops extending axially along the axis of revolution Ox, and generally has a corkscrew shape.

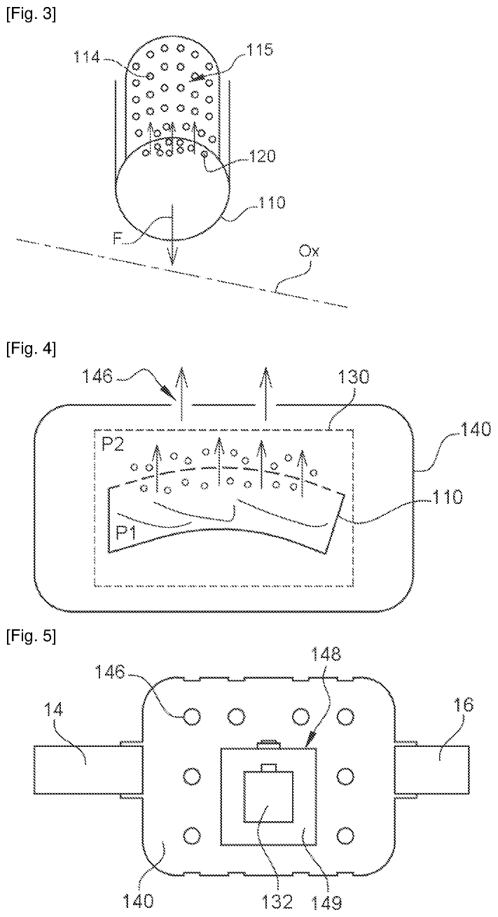

As represented in [FIG. 2] and more particularly in [FIG. 3] which particularly illustrates a transverse section of the spiral tube 110 of the filtration device 100 according to the invention, the spiral tube 110 includes a plurality of openings 114 provided at a radially outer portion 115 of the spiral tube with respect to an axis of revolution Ox substantially parallel to the longitudinal axis L.

Advantageously, the openings 114 are made over the entire length of the spiral tube 110, that is, between the upstream end 111 and the downstream end 112 of the spiral tube 110.

According to an alternative embodiment, it is also contemplated to make the openings 114 on one or more portions distributed over the length of the spiral tube 110.

The diameter of the openings 114 is determined according to the size of the particles that it is desired to filter or extract from the air flow F.

By way of example, for filtration of sand particles having a diameter of 0.01 to 2 mm, the openings 114 may have a diameter of 2 mm.

By virtue of the filtration device 100 according to the invention, the cooling air flow F circulating at a speed V1 and at a pressure P1 in the upstream tube 14 of the utility tube 10 is centrifuged by circulation inside the spiral tube 110.

Thus, the spiral tube 110 is a static element having a geometry allowing a cooling air flow F to be centrifuged.

The centrifugation of the cooling air flow F allows the sand particles 120 to be separated from the air flow by their density difference.

During circulation inside the spiral tube 110, the cooling airflow F and the sand particles 120 are subjected to a centrifugal force imposed by the helical shape of the spiral tube 110.

As can be seen represented in [FIG. 3], the sand particles 120 are thus projected towards a portion 115 of the spiral tube 110 radially outer with respect to the axis of revolution Ox and the sand particles 120 are expelled from the spiral tube 110 via the openings 114.

The filtration device 100 includes a storage tank 130 for receiving the sand particles 120 filtered from the cooling air flow F and expelled from the spiral tube 110.

The storage tank 130 surrounds the spiral tube 110, that is, the spiral tube 110 is housed inside the storage tank 130.

The storage tank 130 forms an enclosure with at least one external wall forming the enclosure shell being porous to air but not allowing the passage of filtered particles, especially filtered sand particles 120.

Thus, the sand particles 120 filtered from the cooling air flow F build up at the bottom of the storage tank 130 under the effect of gravity as illustrated in [FIG. 2].

The storage tank 130 is for example a porous cloth or a porous metal enclosure surrounding the spiral tube 110.

Furthermore, the filtration device 100 includes a protective enclosure 140 forming the external shell of the filtration device 100. The protective enclosure 140 is positioned around the storage tank 130 as well as around the coupling portions between the utility tube 10 and the spiral tube 110. For this purpose, the protective enclosure 140 includes an upstream attachment system 141 and a downstream attachment system 142 for attaching the protective enclosure to the upstream tube 14 and the downstream tube 16 of the utility tube 10, respectively.

The protective enclosure 140 essentially has a role of protecting the device 100, and especially the spiral tube 110, from various impacts or external aggressions.

The filtration device 100 further includes means 144 for securing the storage tank 130 to the protective enclosure 140. Thus, the storage tank 130 is self-supporting and can be centred inside the protective enclosure 140 as illustrated in [FIG. 2].

By way of example, the means 144 for securing the storage tank 130 to the protective enclosure 140 are also configured to limit and/or absorb large movements, vibrations, etc. of the storage tank 130 inside the protective enclosure 140.

The protective enclosure 140 also includes openings 146, especially to allow fluid communication, that is, air exchange, between the exterior and interior of the protective enclosure 140. Thus, as represented by the schematic diagram of [FIG. 4], a pressure P1 inside the spiral tube 110 is guaranteed to be greater than the surrounding pressure P2, and thus an expulsion of the sand particles 120 from the spiral tube 110 is guaranteed.

Indeed, if the protective enclosure 140 were closed and fully sealed, the sand particles 120 would be stuck inside the spiral tube 110 and not expelled by the presence of a pressure inside the protective enclosure 140 greater than the pressure P1 of the cooling air flow F circulating inside the spiral tube 110.

The dimensions of the openings 146 provided at the protective enclosure 140 are determined so as to guarantee a pressure P1 inside the spiral tube 110 greater than the pressure P2 inside the protective enclosure 140, while minimising loss of flow rate of the cooling air flow F taken at the high-pressure compressor compartment. Thus, airflow rate at the outlet of the filtration device 100 is maximised to ensure proper cooling downstream of the filtration device 100, and especially of the low-pressure turbine rotor.

By way of example, the openings 146 are uniformly distributed over at least a portion of the surface of the protective enclosure 140.

With reference to [FIG. 5] which represents an external view of the filtration device 100, the protective enclosure 140 includes an access to the storage tank 130.

Thus, as represented by way of example, the protective enclosure 140 may include an access hatch 148 fitted with a removable panel 149 giving the possibility to access the storage tank 130 when the removable panel 149 is in an open position and providing protection to the elements inside the protective enclosure 140 when the removable panel 149 is in a closed position.

Facing the access hatch 148 of the protective enclosure 140, the storage tank 130 also includes an opening 132 provided at its external shell allowing access to the sand particles 120 accumulated in the storage tank 130, from outside the filtration device 100. The opening 132 is for example an access hatch having a removable panel between an open and a closed position. The opening 132 of the storage tank is represented in cutaway in [FIG. 5].

The access hatches 148, 132 are dimensioned to allow visual control of the filling of the storage tank and/or for the passage of a suction duct 151 of a suction device 150. The access hatches 148, 132 have to be large enough to be able to suck all particles present in the storage tank 130.

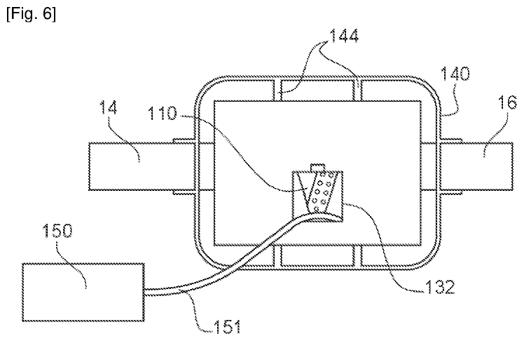

Thus, maintenance operations are facilitated. Given the accesses, it is thus possible to empty the storage tank 130 easily using a conventional suction device 150, as represented in [FIG. 6]. The filtration device 100 according to the invention thus makes it easier to extract the stored sand particles 120, during maintenance operations or during engine inspection operations.

The filtration device 100 may also include a filling detector for communicating the filling rate of the sand particles 120 in the storage tank 130, for example by communicating the filling rate in real time, or by emitting an alarm signal when a threshold filling rate is exceeded.

1. A device for filtering a cooling air flow for cooling a low-pressure turbine of a turbomachine, comprising a duct having a geometry configured to centrifuge said cooling air flow passing through said duct, said duct having openings dimensioned to allow separation of solid particles contained in said cooling air flow being centrifuged, said duct has a circular helix shape inscribed on a cylinder of revolution with an axis of revolution.

2. The device for filtering a cooling air flow according to claim 1, wherein said duct is a tube with a circular cross-section.

3. The device for filtering a cooling air flow according to claim 2, wherein the openings are provided in a radially outer portion of said duct with respect to said axis of revolution.

4. The device for filtering a cooling air flow according to claim 1, further comprising a storage tank for storing solid particles separated from said cooling air flow.

5. The device for filtering a cooling air flow according to claim 4, wherein said storage tank has an air-porous shell.

6. The device for filtering a cooling air flow according to claim 1, further comprising a protective enclosure forming the external shell of said filtration device.

7. The device for filtering a cooling air flow according to claim 6, wherein the protective enclosure has openings allowing the interior of the protective enclosure to be placed in fluid communication with the exterior of the protective enclosure.

8. The device for filtering a cooling air flow according to claim 6, wherein the protective enclosure has an access hatch positioned facing an opening provided at the external shell of the storage tank.

9. A system for cooling a low-pressure turbine, comprising a utility tube for conveying a cooling air flow taken at a high-pressure compressor compartment to a low-pressure turbine compartment, said utility tube including a filtration device according to claim 1, said filtration device being positioned between an upstream tube connected to the high-pressure compressor compartment and a downstream tube connected to the low-pressure turbine compartment.
